(19) United States
(12) Patent Application Publication
(10) Pub. No.: US 2010/0271189 A1
(43) Pub. Date: Oct. 28, 2010

(54) METHOD FOR CONFIGURING AND MONITORING A TRAILER IN TOW USING AN INTEGRATED TRAILER BRAKE CONTROLLER

(76) Inventors: Thomas Lee Miller, Ann Arbor, MI (US); Karl William Wojcik, Sterling Heights, MI (US)

Correspondence Address: ANGELA M. BRUNETTI, PLLC, 3233 Lake Forest Dr., Sterling Heights, MI, 48314, US

(21) Appl. No.: 12/428,006

(22) Filed: Apr. 22, 2009

(51) Int. Cl. G08B 21/00; B60C 23/02

(52) U.S. Cl. 340/431; 340/442

(57) ABSTRACT

A method for configuring a tire pressure monitoring system on a towing vehicle having an integrated trailer brake controller to monitor a tire pressure for a towed vehicle that verifies connection of the towed vehicle to the towing vehicle, detects a signal at the integrated trailer brake controller, the signal being indicative of a confirmation of the trailer connection between the towing vehicle and the towed vehicle and communicates the trailer connection confirmation signal to the tire pressure monitoring system to initiate communication between the tire pressure monitoring system and tire pressure sensors on the towed vehicle.

### TECHNICAL FIELD

The present invention relates generally to a method for configuring and monitoring a towed vehicle tire pressure and more particularly to a method for configuring and monitoring a towed vehicle tire pressure initiated by an integrated trailer brake controller.

### BACKGROUND

The design of passenger vehicles is often driven by safety, utility and consumer convenience. Various types of pressure sensing systems for monitoring the pressure within the tires of a vehicle have been proposed. A system that automatically determines the locations of the tire pressure sensors in the sensing system relative to the vehicle has been proposed. However, such systems typically depend on the vehicle operator to perform a programming, or initiation task, in a predetermined order, to identify and associate the pressure sensors with their respective tire locations.

Such a system is further complicated when the tire pressure is being monitored on a towed vehicle, such as a trailer. It has not been common practice to monitor the tire pressure for the tires on a trailer until recently, when remote (i.e., a system on the towing vehicle) tire pressure monitoring systems have been expanded to include the tires on the trailer. A problem encountered with these remote monitoring systems is that the system has no way of determining when the trailer is in tow and therefore, no way of knowing when to actively monitor the tire pressure sensors on the trailer, unless activated by way of manual intervention.

Manual intervention, as discussed above, is one solution, but typically introduces human error. Automated systems that employ initiators on the tires that are activated by the monitoring system have drawbacks as well. For example, tire pressure sensors equipped with initiators on the trailer may mistakenly identify sensors in cases when the trailer is stored near the towing vehicle, yet is not connected thereto. Furthermore, in cases where the trailer is actually connected to the towing vehicle, but the towing vehicle systems are unaware that the trailer tire's sensors need to be associated with the remote monitoring system there will be no communication between the monitoring system and the sensors on the trailer. For example, a sensor failure on the trailer will not be detected by the remote monitoring system, as the system is unaware that the trailer has been connected because of the lack of association.

There is a need for a method of alerting a remote tire pressure monitoring system to monitor trailer remote tire pressure sensors without human intervention and without introducing the drawbacks associated with automated initiator systems.

### SUMMARY

The present invention provides a method for configuring a tire pressure monitoring system on a towing vehicle having an integrated trailer brake controller to monitor a tire pressure for a towed vehicle comprising the combination of features of the independent claims, preferred optional features being introduced by the dependent claims.

### DESCRIPTION OF DRAWINGS

FIG. 1 is a block diagram showing an arrangement between a vehicle for towing and a towed vehicle;

FIG. 2 is a block diagram of a tire pressure monitoring system;

FIG. 3 is a functional block diagram of the pressure monitoring system; and

FIG. 4 is a flow chart of the method of the inventive subject matter.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DESCRIPTION OF INVENTION

While various aspects of the present invention are described with reference to a particular illustrative embodiment, the invention is not limited to such embodiments, and additional modifications, applications, and embodiments may be implemented without departing from the present invention. In the figures, like reference numbers will be used to illustrate the same components. Those skilled in the art will recognize that the various components set forth herein may be altered without varying from the scope of the inventive subject matter.

FIG. 1 shows an example arrangement between a towing vehicle 10, such as an automotive vehicle and hereinafter referred to as “vehicle 10”, coupled to a vehicle being towed 12, such as a trailer and hereinafter referred to as “trailer 12”. The vehicle 10 and the trailer 12 have wheels 11 and each wheel 11 has a tire pressure sensor circuit 23 that communicates with a pressure monitoring system 16 on the vehicle 10. In FIG. 1 vehicle 10 is shown with four wheels 11 and trailer 12 is shown having two wheels 11. In practice, each of the vehicle 10 or trailer 12 may have more or fewer wheels 11 than shown in FIG. 1. The vehicle 10 is equipped with an integrated trailer brake controller 14, as described in U.S. Pat. No. 6,966,613 entitled “Integrated Passenger Vehicle Trailer Brake Controller” incorporated herein by reference, and the tire pressure monitoring system 16, as described in U.S. Pat. No. 6,771,169 entitled “Tire Pressure Monitoring System with a Signal Initiator” incorporated herein by reference. U.S. Pat. Nos. 6,966,613 and 6,771,169 are both assigned to the assignee of the present invention.

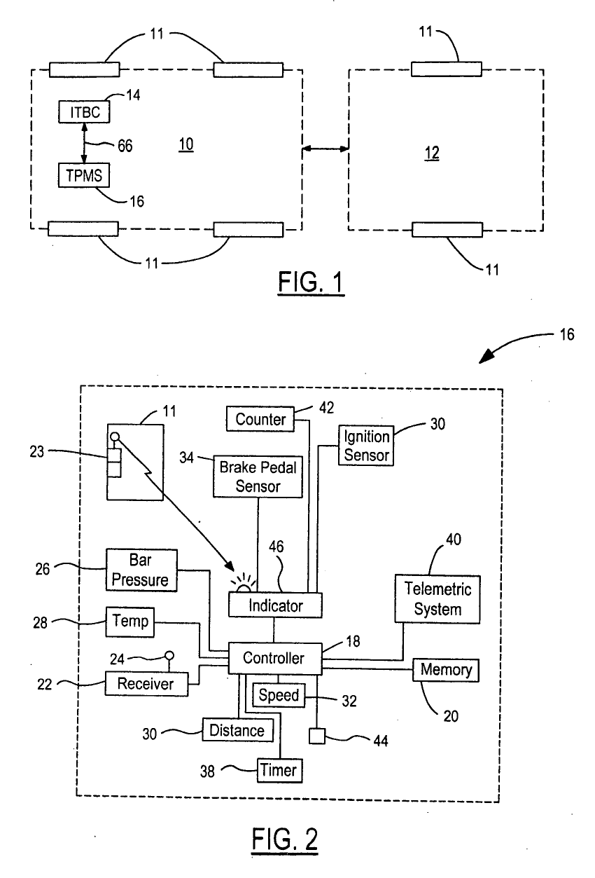

The tire pressure monitoring system 16 is described in greater detail in FIG. 2 which shows a block diagram of a tire pressure monitoring system that may be used according to the inventive subject matter. A controller 18, preferably a microprocessor based controller having a programmable CPU, has a memory 20 associated therewith and stores various thresholds, calibrations, tire characteristics, wheel characteristics, serial numbers, conversion factors, temperature probes, spare tire operating parameters, trailer tire operating parameters, and other values needed in any calculations, calibration and operation of the pressure monitoring system 16. The memory 20 may be various types of memory including ROM or RAM. The memory may be a separate component or it may be part of the controller 18.

Controller 18 may be coupled to a receiver 22 having an antenna 24 associated therewith. Receiver 22 receives pressure and other information from tire pressure circuits 23 on the wheels 11. Controller 18 is also coupled to a plurality of sensors that may include, but are not limited to, a barometric pressure sensor 26, an ambient temperature sensor 28, a distance sensor 30, a speed sensor 32, a brake pedal sensor 34, and an ignition sensor 36. Other types of sensors may also be used. A timer 38 may also be used to measure various times associated with the process set forth herein.

A telemetric system 40 may be used to communicate information to and from a central location on the vehicle 10. For example, the central location may keep track of service intervals and inform the vehicle operator when service is required. A counter 42 may be used to count, for example, the number of times a particular action is performed. A button 44, or plurality of buttons, may be used to input information for resetting the controller 18, or other functions that will be evident to those skilled in the art. Controller 18 may also be coupled to an indicator 46. Indicator 46 may include a light or a display panel, which generates a visual signal, or an audible signal, such as a speaker or a buzzer. Indicator 46 may provide some indication as to operability of the system such as confirming receipt of a signal, calibration of a signal, or other commands, warnings and controls to be described hereinafter.

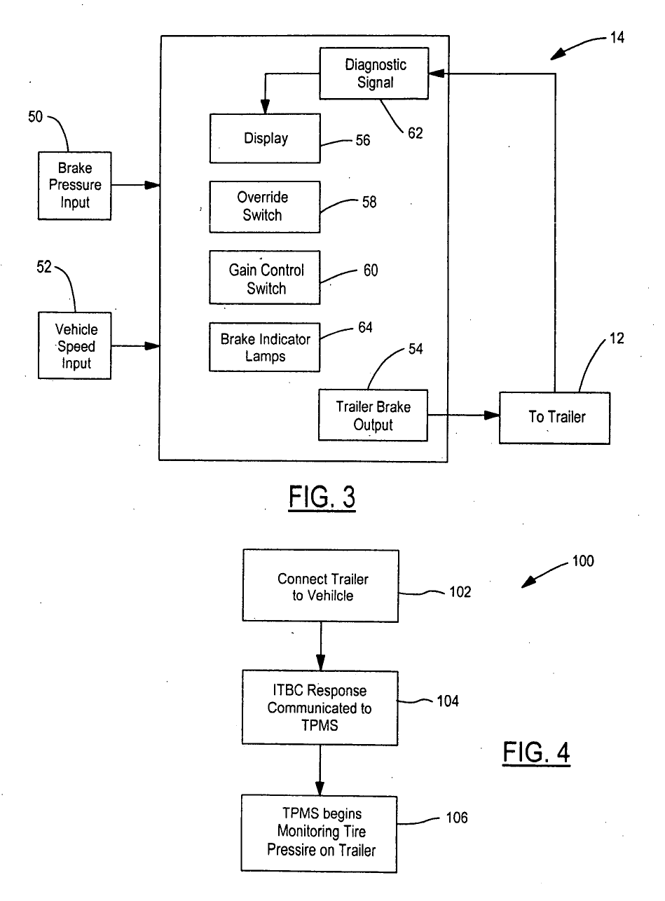

FIG. 3 is a block diagram of the integrated trailer brake controller 14 in the vehicle 10 that includes a control element positioned within the vehicle 10. The integrated trailer brake controller 14 is intended for integration into the vehicle 10 braking system. It is further intended that the trailer brake controller 14 is designed, assembled, and sold with the vehicle 10 such that its control characteristics can be properly set by the vehicle manufacturer for a specific passenger vehicle 10. Additionally, by integrating the trailer brake controller 14 into the vehicle 10 through manufacture, assembly and distribution, control and display features for the trailer brake controller 14 may be professionally integrated into the vehicle 10 design.

The trailer brake controller 14 has a controller 48 having a brake pressure input 50 and a vehicle speed input 52 used to adjust a trailer brake output 54. The brake pressure input 50 may be provided by a brake pressure sensor (not shown), communication with a vehicle anti-lock brake system (ABS) (not shown), or any other variety of known devices or sensors such as a vehicle master cylinder (not shown). The vehicle speed input 52 may be supplied by the vehicle speed sensor 32, the ABS (also not shown), or any variety of know devices or sensors. The integrated trailer brake controller 14 may further provide communication between the controller 48 and the vehicle operator. This communication may take a variety of forms such as a display 56, a user control input 58 such as a gain input control, and an override switch 60. These elements may be adapted and complemented to provide a range of communication and control to the vehicle operator.

A diagnostic input/output 62 may be included to verify proper operation and functionality of the trailer 12. This diagnostic input not only allows the trailer brake controller 14 to inform the vehicle operator of an improper connection but it may also help inform the operator of damage or improper operation of the trailer's braking system. A brake indicator lamp output 64 may be provided and used in conjunction with the integrated trailer brake controller 14 to improve safety and performance of the trailer brake output.

FIG. 4 is a functional block diagram of the interaction between the tire pressure monitoring system 16 that is configured to monitor pressure sensors for the tires on the towed trailer according to the method 100 of the present invention and the integrated trailer brake controller 14 that adjusts the trailer brake output. Upon connection 102 of the trailer to the vehicle, both a mechanical connection and an electrical connection are made. The integrated trailer brake controller responds 104 when the connection is completed and may alert the tire pressure monitoring system to begin monitoring 106 a pressure on the trailer tires. The alert may be in the form of the diagnostic signal.

The integrated trailer brake controller automatically detects when a trailer is physically attached to the tow vehicle. Once the trailer has been connected 102, the integrated trailer brake controller detects the trailer connection. In one embodiment, output drivers for the stop lights on the trailer brake controller are turned “ON” upon connection of the trailer to the towing vehicle. The controller 48 will receive an analog signal 26 that is proportional to a load current when the driver puts a foot on the brake pedal. The controller 48 senses the analog signal thus determining the trailer has been connected. The controller 48 will send a signal 66 to the TPMS 16 that it should begin monitoring a tire pressure on the trailer. The signal 66 provides confirmation to TPMS that the trailer has in fact been connected to the towing vehicle and recognized by the integrated trailer brake controller.

In another embodiment, the method does not rely on the driver's interaction with the brake pedal. In this embodiment, the trailer brake controller detects an open circuit in the absence of a trailer being connected to the tow vehicle. Upon connection of a trailer, the open load is no longer detected, and the controller 48 asserts a “trailer connected” signal. The signal is then communicated to the TPMS so that it knows to begin monitoring tire pressure on the attached trailer.

In another embodiment, the diagnostic output 62 from the integrated trailer brake controller may be used as a signal that is indicative of confirmation that the trailer has in fact been connected to the vehicle. The confirmation signal 66 is communicated to the TPMS to begin monitoring the tire pressure on the trailer.

The inventive subject matter is advantageous in that enables communication between a remote tire pressure monitoring system and an integrated trailer brake controller on a vehicle having a tire pressure monitoring system. This communication is particularly advantageous because it allows the tire pressure for a trailer to be monitored by the tire pressure monitoring system to automatically begin on the towing vehicle, without manual intervention and without errors typically associated with tire pressure monitoring systems that may falsely identify sensors to monitor.

According to the inventive subject matter, connection between the trailer and the towing vehicle is identified and confirmed by the integrated trailer brake controller prior to initiating the tire pressure monitoring system to monitor the trailer tire pressure, thereby avoiding any false indicators and unnecessary trailer pressure updates by the TPMS. For example, the TPMS may detect sensors on a nearby trailer that is not in fact connected to the towing vehicle but is within a detectable distance of the TPMS. Such a false indicator may result in an inaccurate error message should the vehicle move out of range of the unattached trailer and its sensors. Because the present invention identifies and verifies, through the integrated trailer brake controller, that the trailer has in fact been connected to the towing vehicle prior to being communicated to the TPMS for monitoring, any sensor communication, loss of sensor communication, or system failure between the towing vehicle and the sensors on the trailer will be accurately communicated to the driver.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. The components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A method for configuring a tire pressure monitoring system on a towing vehicle having an integrated trailer brake controller to monitor a tire pressure for a towed vehicle, the method comprising the steps of:
connecting the towed vehicle to the towing vehicle;
detecting a signal at the integrated trailer brake controller, the signal being indicative of a confirmation of the trailer connection between the towing vehicle and the towed vehicle;
communicating the trailer connection confirmation signal to the tire pressure monitoring system to initiate communication between the tire pressure monitoring system and tire pressure sensors on the towed vehicle.

2. The method as claimed in claim 1 wherein the trailer connection confirmation signal is a brake indicator lamp signal.

3. The method as claimed in claim 1 wherein the integrated trailer brake controller further comprises an open load detection circuit and the trailer connection confirmation signal is a signal indicative of a failure to detect an open circuit in the open load detection circuit.

4. The method as claimed in claim 1 wherein the trailer connection confirmation signal is a diagnostic signal supplied by the integrated trailer brake controller.

5. The method as claimed in claim 1 wherein the trailer connection confirmation signal is a trailer brake output signal.

6. A method for monitoring a tire pressure for a towed vehicle connected to a towing vehicle having an integrated trailer brake controller and a tire pressure monitoring system, the method comprising the steps of:
detecting connection of the towed vehicle to the towing vehicle using the integrated trailer brake controller to define a confirmation of the connection;
communicating the confirmation of the connection between the towed vehicle and the towing vehicle to the tire pressure monitoring system; and
monitoring a tire pressure on the towed vehicle using the tire pressure monitoring system on the towing vehicle.

7. The method as claimed in claim 6 wherein the step of detecting connection further comprises the step of generating a signal in the integrated trailer brake controller, the signal being proportional to the load current upon connection of the towed vehicle to the towing vehicle.

8. The method as claimed in claim 7 further comprising an open load detection circuit in the integrated trailer brake controller and wherein the step of detecting connection further comprises the step of generating a signal in the integrated trailer brake controller, the signal being a signal indicative of a failure to detect an open circuit in the open load detection.

9. The method as claimed in claim 6 wherein the step of detecting connection further comprises the step of generating a signal in the integrated trailer brake controller, the signal being a brake lamp indicator signal.

10. The method as claimed in claim 6 wherein the step of detecting connection further comprises the step of generating a signal in the integrated trailer brake controller, the signal being a diagnostic signal from the integrated trailer brake controller.

11. The method as claimed in claim 6 wherein the step of detecting connection further comprises the step of generating a signal in the integrated trailer brake controller, the signal being a trailer brake output from the integrated trailer brake controller.

12. A method for configuring a tire pressure monitoring system on a towing vehicle to monitor tire pressure on a towed vehicle, the towed vehicle being connected to the towing vehicle, and the towing vehicle having an integrated trailer brake controller, the method comprising the steps of:
detecting a signal at the integrated trailer brake controller, the signal being indicative of a connection between the towing vehicle and the towed vehicle;
verifying the connection between the towing vehicle and the towed vehicle;
generating a trailer connection confirmation signal at the integrated trailer brake controller; and
communicating the trailer connection confirmation signal to the tire pressure monitoring system to initiate communication between the tire pressure monitoring system on the towing vehicle and the towed vehicle.

13. The method as claimed in claim 12 wherein the trailer connection confirmation signal is a brake indicator lamp signal.

14. The method as claimed in claim 12 wherein the integrated trailer brake controller further comprises an open load detection circuit and the trailer connection confirmation signal is a signal indicative of a failure to detect an open circuit in the open load detection circuit.

15. The method as claimed in claim 12 wherein the trailer connection confirmation signal is a diagnostic signal supplied by the integrated trailer brake controller.

16. The method as claimed in claim 12 wherein the trailer connection confirmation signal is a trailer brake output signal.
